(19) United States
(12) Patent Application Publication
(10) Pub. No.: US 2018/0191490 A1
(43) Pub. Date: Jul. 5, 2018

(54) APPARATUS AND METHOD FOR CARRYING OUT A COMPUTING PROCESS

(71) Applicant: Robert Bosch GmbH, Stuttgart (DE)

(72) Inventors: Sebastien Leger, Stuttgart (DE); Paulius Duplys, Markgroeningen (DE); Robert Szerwinski, Stuttgart (DE)

(73) Assignees: Robert Bosch GmbH, Stuttgart (DE); Robert Bosch GmbH, Stuttgart (DE)

(21) Appl. No.: 15/736,026

(22) PCT Filed: May 12, 2016
(86) PCT No.: PCT/EP2016/060636

§ 371 Date: Dec. 13, 2017

(30) Foreign Application Priority Data
Jun. 17, 2015 (DE) 10 2015 211 108.3

(51) Int. Cl. H04L 9/00; G06F 21/75; G06F 21/76

(52) U.S. Cl. CPC H04L 9/003; G06F 21/76; G06F 21/755

(57) ABSTRACT

A device for carrying out a computing process, in particular a cryptographic process, the device having a primary functional unit that is fashioned to carry out at least a part of the computing process, wherein the device has at least one secondary functional unit that is fashioned to influence, in a specifiable time range, one or more physical parameters of the device.

### FIELD

The present invention relates to a device for carrying out a computing process, in particular a cryptographic process, the device having a primary functional unit that is fashioned in order to carry out at least a part of the computing process.

The present invention also relates to a corresponding method.

### BACKGROUND INFORMATION

Convential data processing devices and methods are used, inter alia, to carry out cryptographic processes, or generally to process security-relevant data, in particular in the area of IT security. Conventionally, the systems and methods, or, more precisely, their concrete hardware and software implementation in a target system, such as a microcontroller or the like, are susceptible to so-called side channel attacks. In such side channel attacks, one or more physical parameters (e.g., power consumption, electromagnetic radiation, etc.) of a system under attack are acquired, and are examined for correlation with secret data such as secret keys of cryptographic processes. From this, an attacker can glean information about the secret key and/or the processed data.

### SUMMARY

An object of the present invention is to provide a device and a method that are less susceptible to the attacks described above.

In accordance with the present invention, an example device has at least one secondary functional unit that is fashioned to influence one or more physical parameters of the device in a specifiable time range. This advantageously makes it possible to make more difficult a synchronization (alignment) of a plurality of measurement series (traces, or leakage traces) of the physical parameters typically ascertained in side channel attacks, because individual measurement series, or traces, can be modified through the influencing according to the present invention in such a way that a relation to other measurement series, which could possibly enable synchronization, is interfered with or destroyed. In this way, side channel attacks can be made more difficult; in particular, they require a greater outlay and are thus more cost-intensive. The approach according to the present invention can also be referred to as “alignment confusion.”

In an advantageous specific embodiment, it is provided that the secondary functional unit is fashioned to influence at least one of the following physical parameters of the device: an electrical energy consumption of the device, in particular a time curve of the electrical energy consumption of the device; an electrical field of the device, in particular a time curve of the electrical field of the device; a magnetic field of the device, in particular a time curve of the magnetic field of the device; an electromagnetic field of the device, in particular a time curve of the electromagnetic field of the device; an electrical potential of a component of the device, in particular a time curve of an electrical potential of a component of the device; an electrical voltage between two components of the device, in particular a time curve of the electrical voltage between the two components of the device. Alternatively or in addition, the influencing according to the present invention can also relate to any other parameter of the device that can be evaluated in the context of side channel attacks, e.g. a spatial temperature distribution in the device, (structure-borne) sound emission, and the like.

In an advantageous specific embodiment, it is provided that the specifiable time range is selected such that it overlaps temporally at least partly with a carrying out of the computing process on the primary functional unit, the specifiable time range preferably being selected such that it temporally overlaps substantially completely (i.e. at least 80%, for example) with a carrying out of the computing process on the primary functional unit. In this way, a particularly effective interference with side channel attacks results.

In an advantageous specific embodiment, it is provided that the secondary functional unit is fashioned to influence the one or more physical parameters of the device by producing a specifiable time curve (“signal shape”) for at least one of the physical parameters. This results in a particularly effective interference with side channel attacks, because the specifiable time curve can advantageously be adapted to actually occurring signal curves (in the context of the carrying out of the computing process on the primary functional unit) of the physical parameter or parameters, and in this way false synchronization information (alignment patterns) can also be produced that further interferes with the side channel attacks.

For example, the secondary functional unit can be fashioned to influence a temporal curve of the physical parameter or parameters in such a way that, at one or more specifiable and/or randomly selectable points in time or periods of time, temporal curves result for the physical parameter or parameters that are identical or similar to temporal curves such as those that occur due to the primary functional unit when carrying out the computing process. If, for example, the carrying out of the computing process on the primary functional unit results in a particular temporal signal curve, e.g. a time curve of the electrical energy consumption, of the device, then the secondary functional unit can be operated or controlled in such a way that it brings about a similar or identical signal curve, here for example a temporal curve of the electrical energy consumption, once or multiple times at different times (specified, or else ascertained in (pseudo-)random fashion), for example by correspondingly temporally modifying its own electrical energy consumption (e.g., through corresponding controlling of a dummy load, carrying out particular computing or processing steps, etc.). If, for example, the carrying out of the computing process on the primary functional unit has a characteristic time curve of the electrical energy consumption having a local maximum (peak), then the secondary functional unit can reproduce this characteristic time curve with the peak, preferably at a plurality of different times, so that a possible side channel attack will erroneously include in its evaluation the time curves or peaks reproduced by the secondary functional unit, because the side channel attack cannot recognize these as deceptive measures intentionally brought about by the secondary functional unit. Particularly advantageously, the secondary functional unit can produce or bring about such characteristic time curves (or an individual one thereof) when the primary functional unit is not at the moment causing such a time curve; in this way, the deceptive effect of the approach according to the present invention is particularly strong, thus causing a strong degree of alignment confusion.

In an advantageous specific embodiment, it is provided that the specifiable time curve is selected as a function of a hardware structure of the device, and/or as a function of the computing process, whereby the false synchronization information (alignment patterns) can be adapted particularly well to the specific device or computing process according to the present invention.

In an advantageous specific embodiment, it is provided that the secondary functional unit is fashioned to dynamically (i.e. during operation of the primary functional unit) modify the specifiable time curve, which further increases security.

In an advantageous specific embodiment, it is provided that the secondary functional unit is fashioned to influence the one or more physical parameters of the device by producing at least one noise signal. In contrast to “interference signals” adapted to actually occurring signal curves of the physical parameter or parameters, in this way random and/or pseudo-random signals can also be used, alternatively or in addition, to make side channel attacks more difficult.

In an advantageous specific embodiment, it is provided that a control unit is provided in order to control the operation of the secondary functional unit.

In a further advantageous specific embodiment, it is provided that the primary functional unit itself is not protected by special, or any, measures against side channel attacks. Rather, in the present invention the protection results from the influencing of the parameters of the device by the secondary functional unit.

In a further advantageous specific embodiment, the secondary functional unit can be completely separate from the primary functional unit. In another advantageous specific environment, the secondary functional unit can be fashioned such that it does not carry out any computing process or cryptographic process, as is the case in the primary functional unit. Rather, the secondary functional unit, in a specific embodiment, can operate as a “signal generator” that influences one or more physical parameters of the device and/or of the primary functional unit that are evaluable in the context of side channel attacks.

In a further advantageous specific embodiment, it is provided that a signal produced by the secondary functional unit in the context of the influencing according to the present invention has a signal energy that is approximately in the range of a signal energy of the relevant physical parameter. If, for example, a time curve of the electrical power consumption of the device is taken as a parameter that can be ascertained in the context of a side channel attack, it is then advantageous if the secondary functional unit has an electrical power consumption, considered in connection with the influencing according to the present invention, whose order of magnitude is at least in the range of that of the electrical power consumption of (the rest of) the device or the primary functional unit.

As a further solution of the object of the present invention, a method is indicated according to patent claim 9. Advantageous realizations are the subject matter of the subclaims.

Below, exemplary specific embodiments of the present invention are explained with reference to the figures.

### BRIEF DESCRIPTION OF THE DRAWINGS

FIG. 1 schematically shows a device according to a first specific embodiment.

FIG. 2 schematically shows a device according to a second specific embodiment.

FIGS. 3a, 3b, 3c schematically each show a time curve of a physical parameter according to further specific embodiments.

FIG. 4 schematically shows a time curve of a physical parameter according to a further specific environment.

FIG. 5 schematically shows a flow diagram of a specific embodiment of the method according to the present invention.

### DETAILED DESCRIPTION OF EXAMPLE EMBODIMENTS

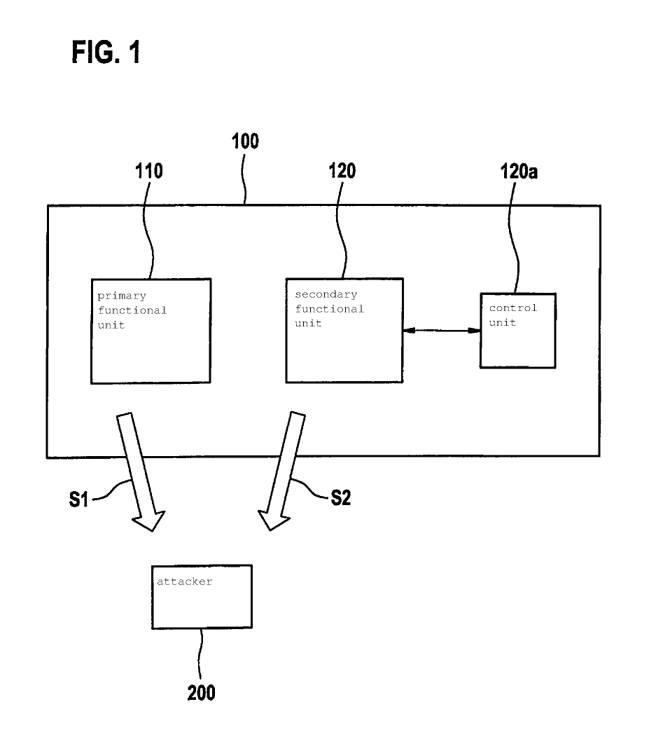

FIG. 1 schematically shows a device 100 for carrying out a computing process, in particular a cryptographic process (e.g., steps or partial steps of the AES algorithm or SHA algorithm or the like), according to a first specific embodiment. The device can for example be realized as a (micro-)processor or digital signal processor (DSP), FPGA (programmable logic module, or Field Programmable Gate Array), ASIC, or the like, and has a primary functional unit 110 that is fashioned to carry out at least a part of the computing process. For example, primary functional unit 110 can be fashioned to apply a cryptographic algorithm to digital data supplied as input data, and to output the output data obtained therefrom to further components, external or internal, of device 100.

A cryptographic “attacker” is designated by reference character 200 in FIG. 1. This can be for example a measurement device that acquires a temporal curve (“trace”) of an electromagnetic radiation of primary functional unit 110 or device 100; cf. block arrow S1.

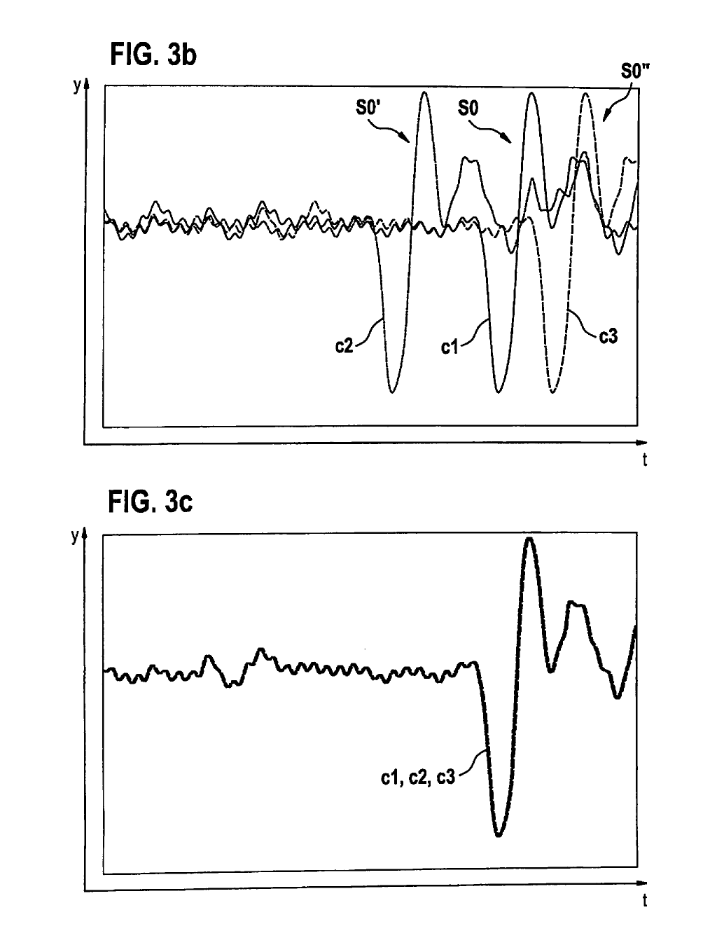

If attacker 200 acquires a multiplicity of traces, then in some circumstances it can infer secret information of primary functional unit 110, such as a secret key of the cryptographic process. For this purpose, standardly, a temporally correlated evaluation of a plurality of time curves (“traces”) is required. FIG. 3a shows as an example a first time curve c1 (amplitude y, in arbitrary units, plotted over a time axis t); a distinctive signal shape S0 in time range t0 is highlighted by frame R1.

FIG. 3b shows, in addition to first time curve c1 according to FIG. 3a, two further time curves c2, c3, as are obtained in further measurements by attacker 200 (FIG. 1). As is shown in FIG. 3b, the two further time curves c2, c3 also have a distinctive signal shape S0′, S0″.

In order to carry out a successful side channel attack, the attacker will attempt to shift the three time curves c1, c2, c3 relative to one another in such a way that their respective characteristic signal shape agrees with the shape of the other time curves; cf. FIG. 3b. For this purpose, the attacker has to be able to correctly identify the respective characteristic signal shape, in particular its temporal position, in the individual time curves c1, c2, c3.

In order to make this more difficult, according to the present invention it is provided that device 100 (FIG. 1) has at least one secondary functional unit 120 that is fashioned to influence one or more physical parameters of device 100 in a specifiable time range. In the present case, secondary functional unit 120 can for example be fashioned to influence the electromagnetic radiation of primary functional unit 110 or of device 100, taking place in the context of the carrying out of the computing process, with the goal of making the synchronization of the individual time curves or traces c1, c2, c3 more difficult.

For example, the secondary functional unit can produce, at one or more times, an electromagnetic signal S2 (FIG. 1) having, at least approximately, signal shape S0 according to FIG. 3a, which acts in the manner of an interference signal for the side channel attack, because it is in itself completely uncorrelated with the carrying out of the computing process on primary functional unit 110. This is because attacker 200 cannot recognize that the signal shape produced by secondary functional unit 120 did not originate in the context of the carrying out of the computing process on primary functional unit 110, but rather was intentionally generated by functional unit 120 for masking purposes. Consequently, the attacker will also include the “interference signal” produced by secondary functional unit 120 in the evaluation of its side channel attack, and will thus increase the entropy thereof, which is undesirable for the side channel attack.

According to other specific embodiments, this effect can also be achieved by “interference signals” having a different shape (than that of S0), produced by secondary functional unit 120. Here what is essential is that secondary functional unit 120 exerts some influence on the at least one physical parameter in a specifiable time range in which the measurement series c1, c2, c3 are ascertained by attacker 200.

In an advantageous specific embodiment, it is provided that secondary functional unit 120 (FIG. 1) is fashioned to influence at least one of the following physical parameters of device 100: an electrical energy consumption of device 100, in particular a time curve of the electrical energy consumption of device 100; an electrical field of device 100, in particular a time curve of the electrical field of device 100; a magnetic field of device 100, in particular a time curve of the magnetic field of device 100; an electromagnetic field of device 100, in particular a time curve of the electromagnetic field of device 100; an electrical potential of a component (e.g. contacting, solder contact, or pin) of device 100, in particular a time curve of an electrical potential of a component of device 100; an electrical voltage between two components of device 100, in particular a time curve of the electrical voltage between the two components of device 100.

In an advantageous specific embodiment, it is provided that the specifiable time range is selected such that it overlaps temporally at least partially with a carrying out of the computing process on primary functional unit 110, the specifiable time range preferably being selected such that it substantially overlaps temporally completely with a carrying out of the computing process on primary functional unit 110. Particularly advantageously, secondary functional unit 120 can carry out such an influencing during the entire operating time of primary functional unit 110.

In an advantageous specific embodiment, it is provided that secondary functional unit 120 is fashioned to influence the one or more physical parameters of device 100 by producing a specifiable time curve for at least one of the physical parameters. For example, secondary functional unit 120 can generate a signal shape comparable to curve c1 from FIG. 3a once or multiple times in a time curve under consideration, e.g. by producing a corresponding magnetic field.

In a particularly advantageous specific embodiment, it is provided that the specifiable time curve within which the influencing according to the present invention takes place is selected as a function of a hardware structure of device 100, and/or as a function of the computing process on primary functional unit 110.

In a particularly advantageous specific embodiment, it is provided that secondary functional unit 120 is fashioned to modify the specifiable time curve dynamically, i.e. during an operation of primary functional unit 110, thus providing further degrees of freedom.

In a particularly advantageous specific embodiment, it is provided that secondary functional unit 120 is fashioned to influence the one or more physical parameters of device 100 by producing at least one noise signal (randomly and/or pseudo-randomly). In this case, the noise signal can also be produced by secondary functional unit 120.

In a particularly advantageous specific embodiment, it is provided that a control unit 120a (FIG. 1) is provided for the controlling of the operation of secondary functional unit 120.

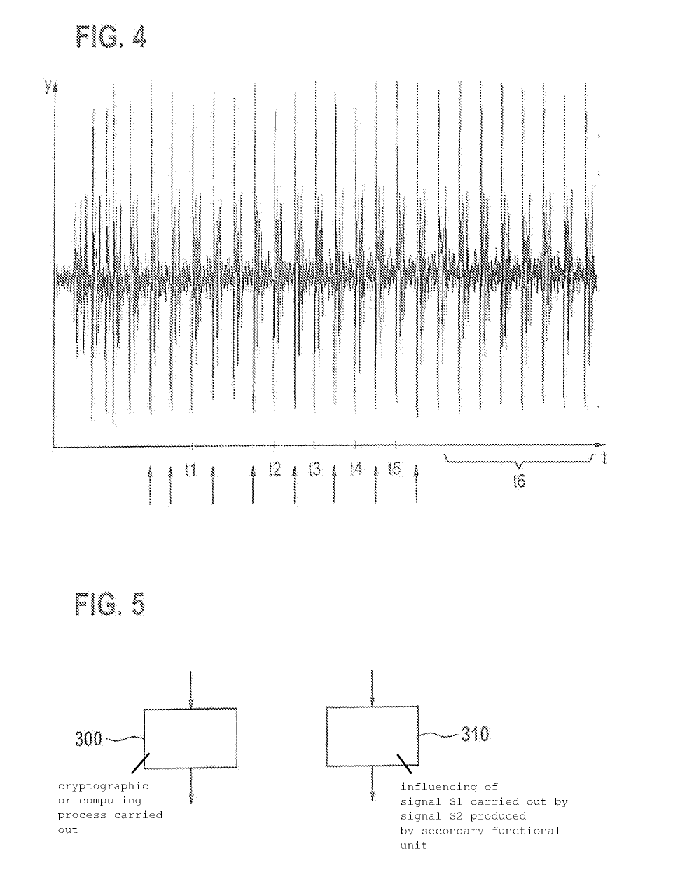

FIG. 4 schematically shows a time curve of a physical parameter, specifically a time curve of the electrical power consumption y of device 100 (FIG. 1) according to a further specific embodiment. At the times marked by vertically upward-pointing arrows in FIG. 4, the electrical power consumption y of device 100 has, as a result of the carrying out of a cryptographic process by primary functional unit 110, characteristic signal curves that can be detected as signal S1 (FIG. 1) by attacker 200. According to the present invention, secondary functional unit 120 influences signal S1 using the additional signal S2 (FIG. 1), which has signal curves comparable to the characteristic signal curves of signal S1, in particular at times t1, t2, t3, t4, t5, t6. According to the present invention, the signal curves S1 that actually arise in the carrying out of the cryptographic process by primary functional unit 110 are thus hidden in signal S2 produced by secondary functional unit S2, which signal S2 correspondingly influences the electrical power consumption y; in this way, alignment confusion can be brought about.

Alternatively or in addition, secondary functional unit 120 can also produce noise signals in order to influence signal S1, according to the present invention. That is, a combination of signals S2, obtained deterministically and non-deterministically, for the influencing of the physical parameter or parameters is also conceivable.

In a further specific embodiment, secondary functional unit 120 can also influence various physical parameters of device 100, simultaneously or with a temporal offset from one another. For example, the producing of characteristic signal shapes S0 for the electrical power consumption can be combined with a simultaneous radiation of electromagnetic fields based on noise signals.

FIG. 5 schematically shows a flow diagram of a specific embodiment of the method according to the present invention. In step 300, the cryptographic or computing process is carried out by primary functional unit 110, and, essentially simultaneously thereto, in step 310 the influencing according to the present invention of signal S1 is carried out by a signal S2 (FIG. 1) produced by secondary functional unit 120.

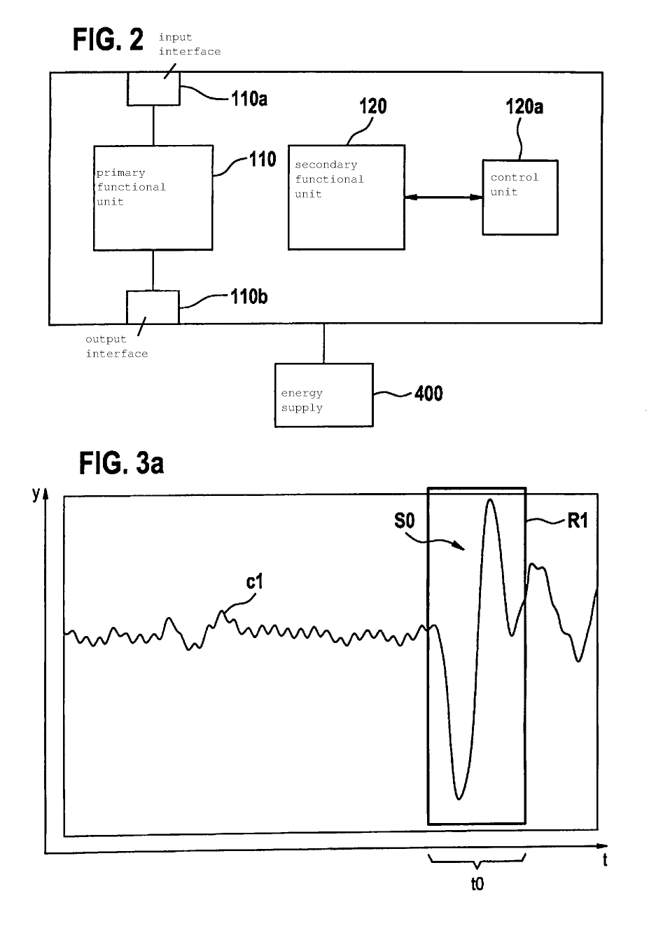

FIG. 2 shows a further variant of the present invention in which primary functional unit 110 has assigned to it an input interface 110a for supplying digital input data and an output interface 110b for outputting digital output data obtained by primary functional unit 110 while carrying out a computing process from the input data.

Component 400 represents a common electrical energy supply. A current consumed by device 100 during the carrying out of the computing process, in a supply line from energy supply 400 to device 100, represents the physical parameter that can be acquired in the context of a side channel attack, or its temporal curve. According to the present invention, secondary functional unit 120 “produces” an interference signal in the form of a specifiable, or random, electrical energy consumption that brings about a corresponding change in current which makes the side channel attack on the computing process in primary functional unit 110 less significant. The production of the “interference signal” by secondary functional unit 120 is controlled by control unit 120a.

The design according to the present invention advantageously enables the securing of computing processes or cryptographic processes, or functional units 110 carrying them out, against side channel attacks, without requiring modification to the functional unit 110 itself that is to be secured.

1-14. (canceled)

15. A device for carrying out a computing process, the computing processing being a cryptographic process, the device comprising:
a primary functional unit configured to carry out at least a part of the computing process; and
at least one secondary functional unit configured to influence, in a specifiable time range, one or more physical parameters of the device.

16. The device as recited in claim 15, wherein the secondary functional unit is configured to influence at least one of the following physical parameters of the device:
a time curve of an electrical energy consumption of the device;
a time curve of an electrical field of the device;
a time curve of a magnetic field of the device;
a time curve of an electromagnetic field of the device;
a time curve of an electrical potential of a component of the device; and
a time curve of an electrical voltage between two components of the device.

17. The device as recited in claim 15, wherein the specifiable time range being selected such that it temporally overlaps at least partly with a carrying out of the computing process on the primary functional unit, the specifiable time range being selected such that it temporally overlaps completely with a carrying out of the computing process on the primary functional unit.

18. The device as recited in claim 15, wherein the secondary functional unit is configured to influence the one or more physical parameters of the device by producing a specifiable time curve for at least one of the physical parameters.

19. The device as recited in claim 18, wherein the specifiable time curve is selected as a function of at least one of: (i) a hardware structure of the device, and (ii) the computing process.

20. The device as recited in claim 18, wherein the secondary functional unit is configured to modify the specifiable time range dynamically during an operation of the primary functional unit.

21. The device as recited in claim 18, wherein the secondary functional unit is configured to influence the one or more physical parameters of the device by producing at least one noise signal.

22. The device as recited in claim 18, further comprising:
a control unit for controlling operation of the secondary functional unit.

23. A method for operating a device for carrying out a computing process, the computing processing being a cryptographic process, the device having a primary functional unit that is fashioned to carry out at least a part of the computing process, and at least one secondary functional unit, the method comprising:
operating the secondary functional unit to influence, in a specifiable time range, one or more physical parameters of the device.

24. The method as recited in claim 23, wherein the secondary functional unit is operated to influence at least one of the following physical parameters of the device:
a time curve of an electrical energy consumption of the device;
a time curve of an electrical field of the device;
a time curve of a magnetic field of the device;
a time curve of an electromagnetic field of the device;
a time curve of an electrical potential of a component of the device; and
a time curve of an electrical voltage between two components of the device.

25. The method as recited in claim 23, wherein the specifiable time range is selected such that it temporally overlaps at least partly with a carrying out of the computing process on the primary functional unit, the specifiable time range being selected such that it temporally overlaps completely with a carrying out of the computing process on the primary functional unit.

26. The method as recited in claim 23, wherein the secondary functional unit influences the one or more physical parameters of the device by producing a specifiable time curve for at least one of the physical parameters.

27. The method as recited in claim 23, wherein the specifiable time curve is selected as a function of at least one of a hardware structure of the device and the computing process, and the specifiable time curve being modified dynamically during an operation of the primary functional unit.

28. The method as recited in claim 23, wherein the secondary functional unit influences the one or more physical parameters of the device by producing at least one noise signal.
